(19) United States
(12) Patent Application Publication
(10) Pub. No.: US 2026/0326474 A1
(43) Pub. Date: Oct. 22, 2026

(54) SECURITY ELEMENT COMPRISING NANOSTRUCTURES

(71) Applicant: GIESECKE+DEVRIENT CURRENCY TECHNOLOGY GMBH, Munchen (DE)

(72) Inventors: Michael RAHM, Bad Tolz (DE); Christian STOCKL, Kinding (Enkering) (DE); Matthias BLAZEK, Bad Wiessee (DE); Moritz HOFER, Munchen (DE); Christian FUHSE, Otterfing (DE)

(21) Appl. No.: 19/109,604

(22) PCT Filed: Sep. 13, 2023
(86) PCT No.: PCT/DE2023/100676

§ 371 Date: Mar. 7, 2025

(30) Foreign Application Priority Data
Sep. 14, 2022 (DE) 10 2022 003 386.0

(51) Int. Cl. B42D 25/328; B42D 25/373

(52) U.S. Cl. CPC B42D 25/328; B42D 25/373

(57) ABSTRACT

A security element for valuable objects or documents features a subwavelength grating structure on a substrate, which displays a color derived from plasmon resonance when viewed perpendicularly. This structure includes multiple sections not resolvable by the naked eye, with each section uniformly containing the subwavelength grating structure. The grating structures vary across these sections in at least one structural parameter that affects light diffraction. Furthermore, the sections cover the surface area of the security element and differ in at least one structural parameter, ensuring that an observer does not notice any rotation-angle-dependent diffraction effects in the area occupied by these sections when the security element is tilted about at least one axis lying in the substrate plane.

The invention relates to a security element for valuable objects or valuable documents, which security element has on a substrate a subwavelength grating structure, which exhibits a color by way of light diffraction and resonance effects, wherein a multiplicity of sections which are not resolvable with the naked eye are formed, in each of which sections the subwavelength grating structure is uniformly formed, wherein the subwavelength grating structures differ between the sections in terms of at least one structure parameter which influences light diffraction. The invention furthermore relates to a method for producing such a security element.

Since the 1980s, holographic gratings having a period of between typically 600 nm and 1500 nm have been used as security features in banknotes and identity cards. For decades they have had an influence on the optical appearance of these documents and ensured the forgery-proofness thereof.

The following aspects are relevant to the term “diffraction structures”. Diffraction is the deflection of waves at an obstacle. Diffraction enables a wave to propagate into spatial areas which would be blocked by the obstacle on a straight path. Any kind of physical waves can exhibit diffraction. Diffraction occurs as a result of new waves arising along a wavefront in accordance with the Huygens-Fresnel principle. These waves can lead to interference phenomena as a result of superimposition. One example is diffraction at the periodic grating (of first or higher order).

That can be realized using periodic structures. One-or two-dimensional periodic structures (“hologram gratings”) having periods of approximately 400 nm to approximately 5 μm typically exhibit colorful “rainbow colors”.

Special optically variable effects can be produced by varying e.g. the grating period and/or azimuth angle. In this case, the parameters can be varied continuously or at least in small steps (e.g. for realizing pump effects). Even larger structures exhibit diffraction effects, but in practice those can be observed only when illumination is directional to the greatest possible extent. In contrast to gratings having a symmetrical profile (sinusoidal gratings, rectangular gratings), blazed gratings have an asymmetrical profile shape (in particular sawtooth profiles). As a result, in a targeted manner it is possible for more intensity to be diffracted e.g. into the +1st order of diffraction than into the −1st order of diffraction, as a result of which asymmetrical representations can be generated. Aperiodic diffraction structures act as “matt structures” and have structure sizes similar to those of hologram gratings, but are arranged irregularly, such that in the diffracted light a superimposition of light of different wavelengths leads to “whitening”. The structures can diffract practically isotropically the same in all directions or only in specific preferred directions. If different structures with different preferred directions are used, e.g. achromatic running effects can be realized. Proceeding from hologram gratings, such structures can be produced by “blurring” the grating lines, i.e. e.g. by varying the line spacings or azimuth angles of individual grating lines.

In recent years, however, the forgery-proofness of the embossing holograms based on the physical effect of diffraction has decreased noticeably owing to the increasing availability of devices for producing these holograms, and so nowadays they can hardly be used any more for the primary safeguarding of valuable documents.

Instead of holograms, therefore, use is preferably made of security features which are based on the use of non-diffractive microstructures, for example micromirrors or microlenses. Forgery of such features is significantly more difficult and they impart to the valuable documents equipped therewith a still unfamiliar and novel appearance associated with a high dynamic characteristic that rapidly draws attention to itself. In this context, the use of color shift coatings, which impart a tilt-angle-dependent color impression to the observer, is also highly effective and additionally increases forgery-proofness.

Coatings with an interference color filter (color shift) generate color by means of multiple reflection of light in a (thin) layer construction. The interference condition is met only for one wavelength, and all other wavelengths have destructive interference. Color generation thus occurs. As the number of layers increases, the color becomes spectrally “purer”, i.e. the interference peak becomes narrower. Typical constructions are three-layer constructions comprising absorber, dielectric and reflector, e.g. absorber Cr (approximately 5 nm), dielectric SiO₂(200 -500 nm), reflector Al (approximately 50 nm).

Micromirrors are facets which reflect incident light essentially according to the laws of geometrical optics. They have dimensions which are significantly (approximately a factor of 10) larger than the light wavelength, in particular dimensions starting from approximately 5 μm. This means that their reflection behavior is largely achromatic. The dimensions are preferably a maximum of 100 μm, particularly preferably a maximum of 40 μm. The micromirrors can be arranged periodically (“sawtooth grating”) or aperiodically. Fresnel structures can also consist wholly or partly of micromirror structures or be approximated by micromirrors. Fresnel structures arise from arbitrarily shaped surfaces by means of cuts with constant height. In this regard, micromirrors can also have for example an arcuate cross-sectional shape and a three-dimensional shape.

Micromirrors are often embodied as rectangular, but honeycomb-shaped (hexagonal) or arbitrarily shaped micromirrors (“mosaic”) are also possible. The surfaces of the micromirrors are preferably formed so as to be plane with defined inclination. At least the most greatly inclined micromirrors have in the profile a height which is significantly greater than the wavelength (>1 μm). The inclinations of the steepest micromirrors are typically of the order of 20°, and even of the order of 10° in specific designs.

The reflectance or the color of the reflected light can be determined by way of the coating, which is present e.g. as a simple surface-conformal metallization such as aluminum or as a high refractive index coating such as e.g. ZnS or in the form of a multilayered color shift construction. The color and/or the reflectance can also be set by means of superimposed subwavelength structures. If micromirrors are not reflectively coated, but rather are at least semitransparent, then it is possible to observe effects similar to those for the mirror effect in reflected light as a result of the prism effect in transmitted light. For the required light refraction, the structures must not be embedded or need to be situated at an interface with a material having a significantly different refractive index.

In parallel with microstructures, optically variable security features based on the use of nanostructures having typical sizes in the subwavelength range, i.e. smaller than 400 nm, have been developed for many years. Use is made of one-or two-dimensionally structured nanostructures in the form of regular subwavelength gratings or in the form of irregular structures, e.g. elevations or depressions arranged irregularly on a base area.

Subwavelength structures are so small that first-or higher-order diffraction effects do not occur in the event of perpendicular light incidence. The structure sizes are smaller than the wavelength of the light. Different effects are utilized here in different structures: Subwavelength gratings (also referred to as “zeroth-order gratings” in the literature) are regular one-or two-dimensional gratings having periods in the subwavelength range (≤400 nm) and generate colors by mirror reflection (“zeroth order”). The subwavelength gratings with a metallic coating utilize plasmon effects for color generation. In the case of gratings with a dielectric (in particular high refractive index) coating, by contrast, colors arise as a result of a different effect, namely as a result of resonant excitation of polaritons. The profile shape may be rectangular or sinusoidal, for example. Upon illumination and observation at shallow angles, first-order diffraction may additionally occur as well.

Moth-eye structures are subwavelength structures which allow an almost reflectionless transition of light from one medium to another. In dielectric materials, such structures act as an “antireflection layer”. The structures can be arranged regularly (periodically) or irregularly and can be present with a tapering cross section or else e.g. as binary rectangular structures. If the moth-eye structures are metallically vapor-deposited, they appear very dark and in particular black.

In the case of nanostructures arranged regularly in a one-or two-dimensional grating, resonance effects such as plasmon excitations, for example, generally lead to color phenomena since the transmission, reflection and absorption of the light incident on the grating are spectrally dependent on parameters that characterize the subwavelength grating in this regard, such as period, depth, profile shape, type of coating and layer thickness of the coating. In particular, the period can be used for setting a specific color impression. The colors which are generated in this way and are perceptible to an observer are generally less brilliant and optically variable than the color phenomena caused by diffraction at a holographic grating, rather they are pastel-colored and observable over a larger angular range without appreciable color change. When viewed without a polarizer, typically even when there is a change in the rotation angle in the structure plane the color impression of subwavelength gratings based on plasmon resonance is very similar to almost identical, i.e. independent of the azimuth angle. These properties make the subwavelength structures of particular interest in security features in which they are combined with microstructures.

Subwavelength structures are understood here to mean structures having dimensions of ≤400 nm. The grating periods of the subwavelength gratings are preferably between 10 nm and 500 nm, preferably between 50 nm and 400 nm, and particularly preferably between 100 nm and 350 nm.

The forgery-proofness of nanostructures is based in particular on the fact that producing them requires high-resolution apparatuses and processes such as are used in electron beam lithography, for example. In comparison with embossing holograms, the nanostructures to be produced are an order of magnitude smaller at any rate. Moreover, the various molding steps for film fabrication that have primarily become established in the embossing tool fabrication process need to take place predictably with dimensional fidelity in order that the structures embossed on film can be seen by the observer e.g. in the desired color.

However, regular subwavelength gratings are still producible even with conventional lithography apparatuses and even laser direct exposure-albeit under more difficult conditions. Therefore, forgery-proofness is still not optimal.

In general, subwavelength gratings are indeed more difficult to produce than hologram gratings with correspondingly larger grating periods, since a higher resolution is required for this purpose. The following holds true: the smaller the structures, the higher the necessary resolution of the apparatuses used. By way of example, laser exposure apparatuses have to be constructed more stably (in regard to mechanical vibrations, temperature) and more precisely (in regard to positioning accuracy) and use lasers with a shorter wavelength.

However, extensive regular subwavelength gratings are in most cases easier to produce than arrangements of gratings with varying parameters. The smaller the uniformly structured surface areas and the larger the number of different parameters, the lower the economic viability or the greater the difficulty of direct exposures. Even for laser writers, it then becomes increasingly more difficult: even if these can still produce the required grating periods, these will then actually generally deviate from the exact shapes originally designed. Even electron beam apparatuses which in principle can produce such structures require more complex data processing.

EP 2 447 743 A1 discloses a security element of the type mentioned in the introduction which provides pixels which are not resolvable by eye and which have subwavelength gratings with a dielectric high refractive index coating. In order to prevent the optical impression of a pixel from changing when the security element is rotated perpendicularly to the surface thereof, each pixel is constructed from subpixels, the subwavelength gratings of which have an individual azimuthal orientation in the pixel. The document refers to the pixels thus obtained as “isotropic pixels”.

EP 2 229 287 A2 relates to a security feature whose surface areas filled with subwavelength gratings become luminous at specific tilt angles and lead to a geometric distortion of the perceptible shapes. Therefore, the corresponding surface areas are predistorted such that they appear undistorted in correct proportions at the specific tilt angles.

Security features which use regular nanostructures, i.e. structures in the form of subwavelength gratings, have a very disturbing optical effect in some cases: At high tilt angles or in the case of light incident shallowly from a specific angle, the observer sees the subwavelength gratings become brightly luminous since the first order of diffraction becomes visible. This may have an appreciable adverse effect on color perception because the original color of the surface area filled with this subwavelength grating is suddenly no longer discernible. Instead, the first order of diffraction outshines the color originally allocated to this surface area. What furthermore has a disconcerting effect is that owing to the sudden brightness of this specific section, the colors of the adjacent surface areas are no longer readily visible either.

Such nanostructures having a regular arrangement, i.e. subwavelength grating structures, are also found in EUR banknotes, for example. The security films of some denominations contain individual surface areas which become luminous in green color when tilted at a high tilt angle, since they are filled with a 300 nm cross grating.

The invention is based on the object of providing a security feature having structure color generation based on subwavelength gratings, viewing of which security feature does not lead to the perception of adverse effects caused by diffraction effects.

The invention is defined in the independent claims. The dependent claims relate to preferred developments.

The security element for valuable objects or valuable documents has on a substrate a subwavelength grating structure. The latter can be a one-or two-dimensional periodic subwavelength grating structure; it exhibits a color in perpendicular plan view. A multiplicity of sections which are not resolvable with the naked eye are formed. Each section has the subwavelength grating structure, which is homogeneously or uniformly formed in the section. Between the sections the subwavelength grating structures differ in terms of at least one structure parameter which influences light diffraction. The multiplicity of sections which are not resolvable with the naked eye cover a surface area of the security element. The sections provided on the surface area differ with regard to the at least one structure parameter such that an observer does not perceive any rotation-angle-dependent diffraction effect in the surface area occupied by the sections when the observer tilts the security element. This tilting is effected about a tilt axis lying in a substrate plane, i.e. changes the elevation angle.

This concept thus envisages that the sections may indeed change with regard to the color impression with the tilting. However, since the sections differ from one another with regard to the structure parameter within the surface area, no significant diffraction-dictated change in the color impression in the surface area is established at large tilt angles overall across the surface area, i.e. averaged over the sections occupying the surface area, when the security element is rotated about an axis that is perpendicular to the substrate plane. A situation where the first order of diffraction becomes brightly luminous, such as occurs at high tilt angles in the case of an (extensive) homogeneous grating when tilted about an axis parallel to the grating lines, does not occur to a significant extent in the case of the security element according to the invention.

The color constancy is particularly high if the subwavelength gratings generate the color on the basis of plasmon resonance, i.e. in particular have a metallically coated relief profile which provides the subwavelength grating structure. Coating material used can be in particular aluminum, gold, silver, copper, chromium, nickel and/or iron and alloys thereof. The thickness of the metallic coating is expediently between 5 nm and 200 nm, preferably between 8 nm and 150 nm, particularly preferably between 15 nm and 80 nm. The metallic coating advantageously forms a substantially opaque coating.

Furthermore, it is also possible, through combination with additional thin layers, to attain even further effects based on a different functional principle, in particular interference effects. Optionally, therefore, an HRI layer, a multilayered coating (e.g. for completing a color shift system comprising absorber/dielectric/reflector) or else a layer sequence composed of HRI and LRI layers (HRI=High Refractive Index; LRI=Low Refractive Index), can also be applied to the metallic coating. Preferably, the HRI layer is formed from ZnS or TiO₂, and the LRI layer is formed e.g. from a polymer or SiO₂ or MgF₂.

The structure parameter individualizes the sections within the surface area. Multiple parameters of the subwavelength grating structure are suitable for this, which parameters can be used individually or in combination for individualization. Mention may be made of the azimuthal orientation, the period, the contour of elevations and/or depressions of the subwavelength grating structure which are arranged regularly on a base area (e.g. rotationally symmetrical contour shapes; non-rotationally symmetrical, e.g. rectangular, in particular square, contour shapes, ellipses, parallelograms, etc.).

In this case, it is possible, in particular, to combine a plurality of sections into groups, wherein a first parameter within a group individualizes the sections, and the groups differ from one another in a second parameter. Equally, it is possible for the sections in each group to be individualized by a different parameter. In this regard, for example, the individualization can result from an azimuthal orientation in the sections of one group, and from the variation of the period in another group.

Particularly preferably, adjacent, different sections of the surface area have a variation of the azimuthal orientation of between 0° and 360°. Likewise particularly preferably, the period of adjacent, different sections of the surface area differs by a value of a maximum of 10% (e.g. 30 nm in the case of 300 nm), preferably of a maximum of 5% (e.g. 15 nm in the case of 300 nm).

In one advantageous configuration, in the surface area the structure parameter is varied substantially isotropically. In particular, a random or pseudorandom variation of the parameter within a variation range is possible.

Pseudorandom numbers are sequences of numbers which appear random, but are calculated by a deterministic algorithm and are therefore not true random numbers in the strict sense. Nevertheless, pseudorandom numbers are widely used since the statistical properties of a pseudorandom number distribution, such as equiprobability of the individual numbers or the statistical independence of successive numbers, are generally sufficiently irregular for practical purposes, such as for the pseudorandom variation of the azimuth angle, for example, and pseudorandom numbers are easy to generate using computers, in contrast to true random numbers.

The security element can advantageously have a plurality of surface areas. In this case, the surface areas typically form individual regions within a motif which each have a uniform color according to the chosen design. If the motif is an apple tree, for example, a first surface area can form the brown trunk, a second surface area can form the green crown, and a third surface area can form a red apple. In a more detailed design, for instance, the crown itself could consist of different surface areas in varying green shades, or the color of the apples could vary between red and yellow, such that each apple represents a dedicated surface area with a color assigned thereto from the spectrum between red and yellow. Each apple could also consist of different surface areas with colors from the spectrum between red and yellow.

The configuration of the surface area by means of a plurality of sections which are individualized by the at least one structure parameter can advantageously be combined with a micromirror arrangement, wherein the surface areas are formed on the micromirror arrangement.

Particularly preferably, the surface areas are combined with a micromirror arrangement in such a way that the surface areas are each formed as a micromirror of said micromirror arrangement. The subwavelength grating structure of the sections of each micromirror imparts a specific color thereto, the color being substantially independent of the elevation angle. The micromirror arrangement thus generates a colorful or colored motif. Tilting of the security element then results in a desired effect being produced, wherein the color or color intensity of the individual micromirrors, on account of the individualized sections, is not adversely affected by diffraction effects of the color-imparting subwavelength structure.

In these cases, the surface areas are preferably not resolvable with the naked eye, since the individual micromirrors are preferably below the resolution limit. In other embodiments, larger surface areas are created, which are resolvable with the naked eye but nevertheless have a uniform color effect stemming from a subwavelength structure which is formed in a multiplicity of sections not resolvable with the naked eye and which is difficult for a forger to copy.

In a further particularly preferred embodiment, the surface areas correspond to micromirror pixels containing a plurality of micromirrors with a uniform orientation. The pixel size of the micromirror pixels is typically in the range of 10 μm to 30 μm, in particular 20 μm. The sections can congruently correspond to the micromirrors within a micromirror pixel. This is not absolutely necessary, however. The limits of the micromirrors and of the sections can also extend independently of one another within a micromirror pixel. In order to avoid interfaces and attendant weakening of the color effect, the sections should not be significantly smaller than the micromirror pixel size. Typical dimensions for the sections are therefore for example a minimum of approximately 4 to 5 μm per section given a dimensioning of the micromirror pixel of approximately 10 μm×10 μm.

In yet another particularly preferred embodiment, the surface areas each correspond to a multiplicity of micromirror pixels (i.e. areas each containing micromirrors with a uniform orientation). Here, too, the pixel size of the micromirror pixels is typically in the range of 10 μm to 30 μm, in particular 20 μm. By way of example, each micromirror pixel has e.g. dimensions of 20 μm×20 μm. Preferably, the sections congruently correspond to the micromirror pixels within a surface area. This is not absolutely necessary, however. The limits of the micromirror pixels and of the sections can also extend independently of one another within the surface area. In typical configurations, a plurality of micromirror pixels have the same color. In this case, it is not absolutely necessary for the micromirror pixels to all have the same orientation or inclination (or for all the micromirror pixels to have matching orientation/inclination of the micromirrors within the micromirror pixels). Rather, the orientation/inclination of the micromirror pixels can vary in the surface area.

The surface areas to be filled with structure colors by way of subwavelength gratings are subdivided into sections having a size below the resolving power of the human eye. These sections are filled with subwavelength gratings which are uniquely defined by a specific parameter set and homogeneously fill up their respective section. The subwavelength gratings in the sections can be both one-and two-dimensional periodic subwavelength gratings. The subwavelength gratings of adjacent sections within a surface area differ from one another with regard to at least one structure parameter which influences the diffraction properties, wherein this difference has no effect or hardly any effect visually upon perpendicular viewing, such that in this state the generated structure color, compared with the structure color generated by each of the individual sections, appears to the observer to be identical or at least very similar.

In particular, upon illumination and viewing at shallow angles, no maxima to be assigned to the first order of diffraction occur which could significantly alter or outshine the generated structure colors. The failure of the first order of diffraction to become brightly luminous is ascertainable with the naked eye without aids. Furthermore, any residual diffraction that possibly occurs takes place azimuthally uniformly and with significantly reduced intensity. The disclosed security feature additionally forms a higher hurdle to forgery attempts.

The diffraction and/or resonance properties of the subwavelength gratings are essentially defined by the following structure parameters, which can be used individually or in combination for individualization of the sections:
period between 10 nm and 500 nm, preferably between 50 nm and 400 nm, particularly preferably between 100 nm and 350 nm;
depth between 50 nm and 400 nm, preferably between 80 nm and 300 nm;
one-dimensional (linear) or two-dimensional gratings; in the case of two-dimensional gratings e.g. rectangular, square, hexagonal or else parallelogram-shaped grid arrangement;
azimuthal orientation of the gratings in the plane of the security feature, relative to a predefined direction;
profile shape of the relief structure: sinusoidal, rectangular (binary) structures or other profile shapes with concave and/or convex portions; a periodic arrangement of nanoholes or nanodots with diverse contour shapes is also possible.

The gratings are preferably uniformly metallically coated since a readily recognizable color which does not change significantly over a relatively large angular range is then generated. In another preferred embodiment, the metallization is effected in areas. By way of example, the top areas of embossed elevations (“columns”) are provided with a coating, while the remaining surface areas do not have a coating. The opposite embodiment—regularly arranged holes in a metal layer—is also possible.

The azimuth angle, i.e. the orientation of the regular subwavelength gratings in the plane defined by the substrate, is particularly well suited as a structure parameter to be varied in the sections, since, in the case of non-polarized illumination, it has substantially no influence on the color generated by plasmon resonance effects upon perpendicular viewing and essentially only affects the diffraction. Particularly preferably, the azimuth angle of the sections which are filled with the subwavelength gratings and which together constitute the entire surface area to be filled with a substantially uniform structure color varies randomly or pseudorandomly within a predefined variation range.

This means that the azimuth angle of each section can assume an arbitrary value between 0 and 360°, such that on account of the multiplicity of sections into which a substantially homogeneously colored area is subdivided, subwavelength gratings occur with diverse azimuth angles and approximately an equal azimuthal distribution, i.e. substantially isotropically over the entire angular range. What is thereby achieved is that an observer cannot see any change as a result of diffraction effects, or at least any dependence of the diffraction color on the azimuthal direction in which the security feature is located or from which the security feature is viewed.

Furthermore, other structure parameters can also be varied across the sections. It is also possible to vary the sections occurring in different-colored surface areas according to respectively different structure parameters, e.g. to vary the period in a surface area filled with a blue structure color and to vary the azimuth angle from section to section in a surface area filled with a yellow structure color.

Furthermore, it is also possible to vary a plurality of grating parameters simultaneously within a surface area, the structure parameters of azimuth angle and period being preferred in this case, too.

The sections have-as explained above-a lateral extent below the resolving power of the human eye. Their size is therefore less than 300 μm, preferably less than 100 μm, particularly preferably less than 50 μm. This applies to their maximum extent at least in one spatial direction, that is to say that the sections can be very narrow, elongated lines, even if sections having dimensions in all directions below the resolution limit are preferred. The sections can have irregular contours, but they can also occur in the form of regularly arranged pixels.

In specific embodiment variants, the subject matter of the invention can also be combined with one or more further sections, in which the grating parameters are not varied at all. In this regard, for example, provision can be made for small sections (e.g. subpixels with an edge length of 10 μm) to be present over a large area, the azimuth angles being chosen randomly in these sections, while further sections each contain a grating having an identical azimuth angle (for example as a denomination legible with the naked eye). In perpendicular plan view, the small sections with a varying azimuth angle and the further sections with an identical azimuth angle, said further sections preferably likewise not being resolvable with the naked eye, are not able to be differentiated or are at least hardly able to be differentiated, while upon suitable viewing (upon tilting about an axis parallel to the grating lines) at a shallow angle, as a result of the otherwise undesirable first order of diffraction of the macroscopic subregion formed from the further sections with an identical azimuth angle, a further representation becomes visible here.

Such a combination additionally facilitates unambiguous verification of the feature according to the invention: Absence of brightly luminous diffraction effects from the first order is not always able to be checked unequivocally, under certain circumstances, since in practice this may e.g. also be attributable to poor lighting conditions or to the fact that an observer does not look for that accurately enough. However, if a grating with fixed grating parameters is provided in a macroscopic subregion, i.e. one perceptible with the naked eye, the subregion being formed from further sections, then an observer obtains an unambiguous result if these further sections become brightly luminous in the first order of diffraction, but the other sections do not exhibit such an effect.

According to a further example, it can be provided that in a contour line of a motif (for example in the form of a symbol legible with the naked eye) which is dimensioned with lateral dimensions below the resolution limit of the eye (e.g. 60 μm), small sections (e.g. subpixels having an edge length of 10 μm) in which the azimuth angles are chosen randomly are present, while a (continuous) subwavelength grating is present in a further section. As in the abovementioned example, the small sections with a varying azimuth angle and the further section are not able to be differentiated in perpendicular plan view. Upon viewing at a shallow angle, however, as a result of the residual diffraction that occurs to a small extent in the small sections with a varying azimuth angle, a motif representation becomes visible, although the latter is outshone by the first order of diffraction upon viewing from a direction perpendicular to the grating lines of the further section (or upon tilting about an axis parallel to the grating lines), such that the motif formed by the contour line disappears again in the case of this viewing situation attainable by changing the rotation angle.

Such a combination also facilitates the verification of the feature according to the invention. The provision of the subregion which contains the small sections with a varying azimuth angle and is dimensioned with lateral dimensions below the resolution limit of the eye additionally ensures that the surface area is perceptible overall with a uniform color and/or brightness. A subdivision of the (macroscopic) further section into sections which are not perceptible with the naked eye is therefore not absolutely necessary for realizing an overall uniform appearance. Accordingly, a continuous subwavelength grating can be provided here in the entire further section.

Subwavelength gratings are produced for example by the following process:
electron beam lithography;
producing an embossing tool by electrolytic molding steps;
embossing in thermoplastic or radiation-curing, in particular UV-curing, embossing lacquer;
metallizing (e.g. with Al, Au, Ag, Cr, Ni, Cu, Fe or alloys thereof), possibly additionally with an HRI layer (e.g. ZnS); a multilayered coating is also conceivable and advantageously usable (e.g. a color shift system comprising absorber/dielectric/reflector, wherein the subwavelength structure varies the color shift color);
optionally embedding the coated embossing structures (e.g. with protective lacquer).

Besides the visually perceptible difference of the arrangements of subwavelength gratings described here in comparison with the prior art, in which the gratings fill uniformly colored surface areas homogeneously with a constant set of grating parameters, the security features according to the invention have a further advantage: they are practically not replicable with a direct exposure with the aid of lasers using interference at the location of the sample, since the multiplicity of variably filled sections and the smallness of these sections would make direct exposure too difficult and too complex. Moreover, the small grating periods ensure that other optical methods for origination are also ruled out. Production with the aid of electron beam apparatuses is possible, but requires greater complexity in terms of data processing. This presents a double hurdle for forgers. In this regard, electron beam apparatuses are inherently already very expensive and therefore not easily accessible to forgers. Furthermore, the software that additionally has to be created for data processing presents a further obstacle.

These nanostructures are of particular interest in security features in which they are combined with microstructures. While the microstructures principally provide for a high dynamic range and optical variability associated therewith, the subwavelength grating structures impart characteristic colors to the feature.

The previously described measures for producing colored representations based on structure colors for security features are therefore manifested particularly advantageously in a superimposition with microstructures. The structures are more complex and more difficult to produce than the subwavelength gratings known in the prior art. The microstructures make an additional contribution to suppressing diffraction phenomena since the diffraction condition-i.e. when an incident light beam is diffracted to the observer-also depends on the orientation of the micro-area on which a subwavelength grating is positioned. Furthermore, the microstructures ensure the dynamic characteristic, while the subwavelength gratings provide the corresponding colors.

In a series of experiments, for example, two motifs of a binary micromirror tilt image with noisy micromirrors in one direction were additionally equipped with nanostructures in order to impart a color to them. The nanostructures situated on the micromirrors consisted of subwavelength cross gratings having a sinusoidal profile, which were subdivided into regular subpixels 20 μm in size as sections, wherein the azimuthal orientation of the subwavelength cross gratings changed randomly from subpixel to subpixel. While the remaining (azimuthally uniformly distributed) residual diffraction was still faintly visible in the tilt image with the least noisy micromirrors, it decreased with increasing variation of the mirror orientation and was finally no longer discernible where the noise level was greatest.

In one particularly preferred embodiment of the production method, the azimuth angle is varied in the sections, i.e. an orientation of the regular periodic subwavelength grating structure in the plane defined by the substrate is varied from section to section.

The individual sections contain particularly preferably two-dimensionally periodically arranged subwavelength grating structures which are preferably applied to the substrate in a rectangular, square, hexagonal or parallelogram-shaped grid arrangement. The two-dimensional periodic subwavelength grating structures have regularly arranged elevations and depressions, wherein in the plan view of the security element the elevations are in particular non-rotationally symmetrical, e.g. rectangular, particularly preferably square. The elevations are not restricted to square or rectangular shapes, of course, in their top sides discernible in the plan view. Other non-rotationally symmetrical shapes are also suitable, such as for instance ellipses, parallelograms.

For simple production, it is preferred for the azimuth angle to change from section to section but for an orientation of the elevations in the plan view always to be the same in all the sections, independently of the azimuth angle. This is explained in more specific detail below on the basis of one example:

In one example, the elevations are rectangular in plan view. The edges of all the elevations are parallel to one another, i.e. the rectangles discernible in plan view all have the same orientation. In order to vary the azimuth angle, the grid arrangement is rotated by a specific angle from section to section, the parallelism of the edges of the elevations being maintained across all the sections. Each elevation with a defined register point, which is the same for all the elevations, is fixed at an intersection point of grating lines of a grating, such that the register point becomes located exactly on this intersection point. The register point can be for example the center of an elevation that is rectangular in plan view, but any other point can also be used as register point. The sections differ in the orientation of the grid arrangement, but not in the orientation of the elevations located in each case with their register point on the respective intersection point.

The preferred production method described is likewise suitable for one-dimensional periodic subwavelength grating structures. The horizontal or vertical spacings of the elevations are then chosen to be equal to zero, such that a quasi-one-dimensional periodic subwavelength grating structure with grating ridges and grating gaps is provided.

With the preferred production method, the subwavelength grating structure can be exposed more rapidly and thus also produced more simply on account of the orientation of the non-rotationally symmetrical elevations that is identical in all the sections.

The invention is explained in even greater detail below on the basis of exemplary embodiments with reference to the accompanying drawings, which likewise disclose features essential to the invention. These exemplary embodiments serve merely for illustration and should not be interpreted as limiting. By way of example, a description of an exemplary embodiment with a plurality of elements or components should not be interpreted to the effect that all these elements or components are necessary for implementation. Rather, other exemplary embodiments may also contain alternative elements and components, fewer elements or components or additional elements or components. Elements or components of different exemplary embodiments can be combined with one another, unless stated otherwise. Modifications and alterations described for one of the exemplary embodiments may also be applicable to other exemplary embodiments. In order to avoid repetitions, elements that are identical or correspond to one another in different figures are designated by identical reference signs and are not explained repeatedly. In the figures:

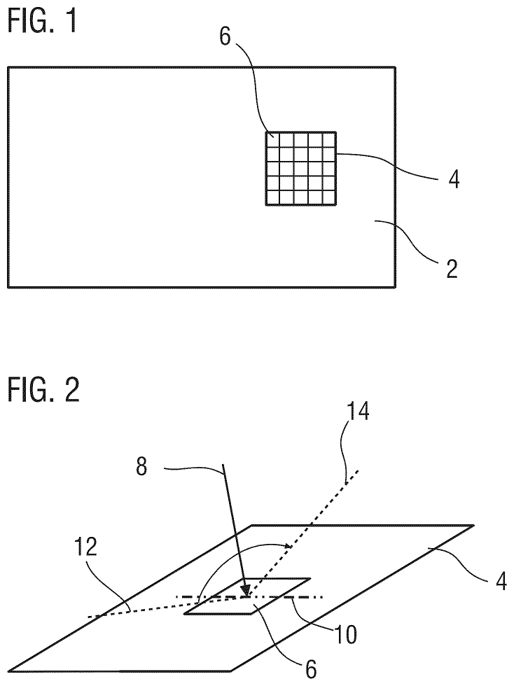

FIG. 1 shows a schematic illustration of a banknote with a security element,

FIG. 2 shows a perspective schematic illustration of the security element for elucidating a tilt effect,

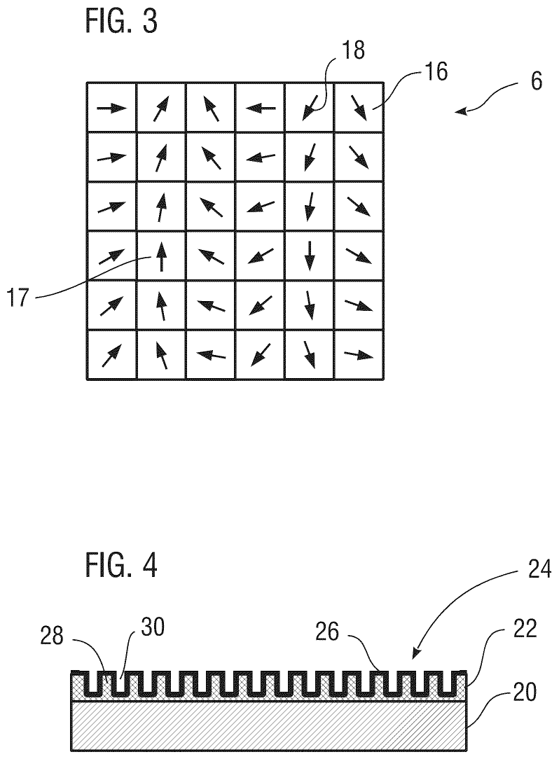

FIG. 3 shows a plan view of the security element from FIG. 1,

FIG. 4 shows a sectional illustration through a partial area of the security element from FIG. 3,

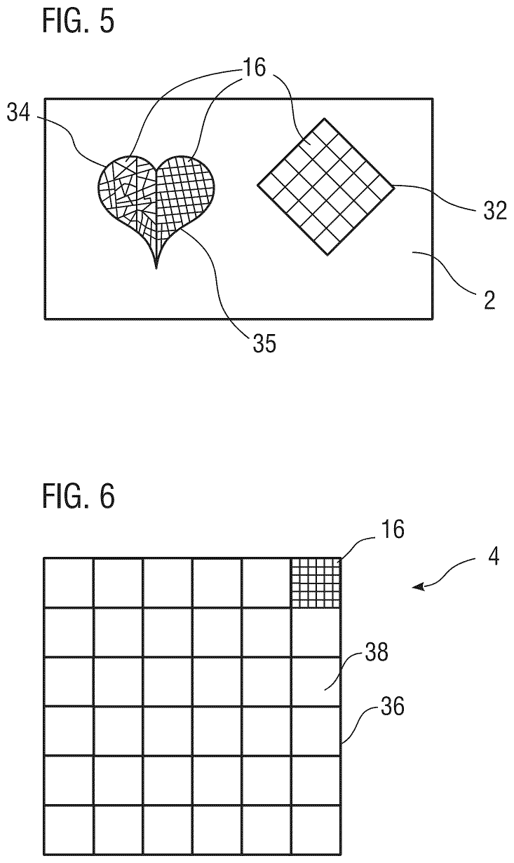

FIG. 5 shows a further embodiment of a banknote with two security elements, similar to the one in FIG. 4,

FIG. 6 shows a further plan view of a security element,

FIGS. 7 to 9 show plan views of a section of the security element,

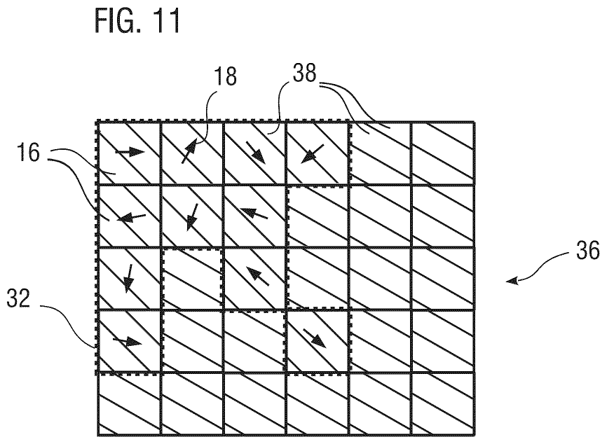

FIG. 10 shows a detail view of an elevation in the plan view, and

FIG. 11 shows a plan view of a section of a security element.

FIG. 1 schematically shows a banknote 2 or some other valuable document provided with a security element 4 for protection against copying. The security element 4 presents a motif to an observer and has a plurality of pixels or surface areas 6 for this purpose. During the production of a banknote paper, the security element 4 can be formed directly thereon. Alternatively, it is possible to provide this on a separate substrate, which is applied to the banknote 2, for example by the security element 4 having been formed beforehand as a so-called transfer element. Suchlike is known to a person skilled in the art.

FIG. 2 shows a plan view of the security element 4, only one of the pixels 6 being depicted for explanation purposes. The security element 4 and thus the pixel 6 is viewed e.g. substantially perpendicularly from a plan view direction 8. All the pixels 6 of the security element 4 have a subwavelength grating, still to be explained, where the definitions of terms explained above also apply, of course, to the depictions of the exemplary embodiments in FIGS. 1-11. If the security element 4 is tilted about an axis 10 lying in a plane defined by the planar security element 4 and/or the planar banknote 2, the plan view direction 8 changes accordingly. Nevertheless, the color presented by the pixel 6 remains substantially unchanged over a wide viewing angle range, the limits of which are schematically designated by 12 and 14. Subwavelength gratings are thus also optically variable, even though their optical variability is less pronounced than is the case for the conventional diffraction gratings. In particular, no diffraction effects are perceptible over a wide tilt angle range, and in addition no azimuth-dependent diffraction phenomena occur.

This property of each pixel 6 is attained by virtue of the fact that, as shown schematically by FIG. 3, which illustrates one of the pixels 6 in plan view, said pixel is formed from a plurality of sections 16, here in the form of subpixels, each of which is formed by a subwavelength grating structure. The individual sections 16 differ with regard to a parameter which influences light diffraction. In the plan view in FIG. 3 this is the azimuthal orientation or a longitudinal direction 18 in which the subwavelength grating structure extends, which here by way of example is a one-dimensionally periodic subwavelength grating structure.

In an embodiment that is not illustrated here, the grating lines of a one-dimensionally periodic subwavelength grating structure can transition from one section continuously in the form of curved lines into the grating lines of another section or other sections with the same period, but rotated azimuth. It is thereby possible to avoid or at least minimize discontinuities at the boundaries of the sections occupied by different subwavelength gratings.

FIG. 4 shows a sectional illustration through the section 17 (FIG. 3) along a horizontally extending axis. The sectional illustration in FIG. 4 shows that the security element 4 is formed on a substrate 20, on which is arranged an embossing lacquer layer 22, into which a relief of a subwavelength grating structure 24 is embossed. The latter is periodic at least in the sectional plane and extends e.g. in a longitudinal direction perpendicular to the plane of the drawing. Said subwavelength grating structure consists of a multiplicity of elevations 28 and depressions 30, which succeed one another one-dimensionally periodically in the example illustrated. A two-dimensional, periodic grating structure is equally possible, of course. In that case there are generally two directions that may each serve as a longitudinal direction 18. The relief structure is provided with a metallization layer 26.

The sections 16 of the pixel 6 can be understood as subpixels. In this case, all the sections 16 of a pixel 6 generate the same color, i.e. are designed with regard to their subwavelength grating 24 such that they present the same or at least substantially the same color. They differ, however, with regard to the longitudinal direction 18 along which the subwavelength grating structure 24 extends. In the exemplary embodiment illustrated in FIG. 3, a subdivision into 36 sections 16 is provided for the pixel 6, the longitudinal direction 18 of said sections differing from one another in each case by 10 degrees. The longitudinal directions 18 of the subwavelength grating structures 24 are thus distributed uniformly between 0° and 360° in the exemplary embodiment. The sections 16 succeeding one another with regard to the variation of the longitudinal direction 18 need not be lined up regularly, as is the case from the top left to the bottom right column by column in FIG. 3. The individual longitudinal directions 18 can also be distributed totally randomly or pseudorandomly among the individual sections 16.

Furthermore, the subwavelength grating structure 24 is not restricted to a one-dimensionally periodic structure, nor is the variation restricted to a variation of the longitudinal direction 18. It is equally possible also to use other subwavelength grating structures and to vary other parameters of this subwavelength grating structure, as explained in the general part of the description. In particular, it is possible to realize the subwavelength grating structure 24 by way of a two-dimensionally periodic arrangement of elevations and/or depressions and/or to vary a period between the individual sections 16, rather than a longitudinal direction 18, as parameter.

FIG. 5 shows that the division into sections 16 is not directed to the subdivision of pixels 6, i.e. of surface areas which are not resolvable with the naked eye, but rather can equally also be used for larger areas 32, 34, 35 which are subdivided into sections 16 which are not resolvable with the naked eye. FIG. 5 shows by way of example here that the sections 16 need not necessarily be arranged regularly or have the same basic structure.

FIG. 6 shows a further embodiment of the security element 4, which in this variant is formed as a micromirror arrangement 36 constructed from individually oriented micromirrors 38. Each of the micromirrors 38 comprises a multiplicity of sections 16, which can differ from one another, as explained on the basis of the pixel 6 in FIG. 3, for example in terms of the longitudinal direction 18 of the subwavelength grating structure 24. Of course, the options regarding how the individual sections 16 can differ from one another, which were explained with reference to FIGS. 3 and 4 and also are mentioned in the general part of the description, equally also apply to the sections 16 on a micromirror 38. The configuration of the micromirrors 38 by way of a multiplicity of sections 16 which differ in at least one parameter has the advantage that the individual micromirrors 38 of the micromirror arrangement 36 exhibit the desired color independently of their orientation and there is no occurrence of the effect that, in the case of a specific orientation of the micromirror 38 that ultimately corresponds to a tilt angle in accordance with FIG. 2, the desired color is not visible at all and/or is adversely affected or disturbed by a higher order of diffraction, for example the first order of diffraction.

FIG. 11 shows a plan view of a detail of a further embodiment of a security element, which, just like the security element shown in FIG. 6, is formed as a micromirror arrangement 36 constructed from individually oriented micromirrors 38. In contrast to the configuration shown in FIG. 6, the micromirrors are present in micromirror pixels each containing a plurality of micromirrors with a uniform azimuthal orientation (and inclination) (indicated by corresponding hatching in the figure). In this case, a plurality of micromirror pixels have the same color predefined by a subwavelength grating structure.

The division into sections 16 which are not resolvable with the naked eye is effected here for larger areas 32, which can be perceptible with the naked eye and one of which is illustrated as a detail with a dashed contour line included in the figure merely for illustration purposes (and with the longitudinal direction 18 of the subwavelength grating structures). The sections 16 of the areas 32 are designed with regard to their subwavelength grating such that they present the same color. They differ from one another, however, as explained on the basis of the pixel 6 in FIG. 3, with regard to a parameter which influences light diffraction. In the plan view in FIG. 11 this is the azimuthal orientation or a longitudinal direction 18 in which the subwavelength grating structure extends, which here by way of example is a one-dimensionally periodic subwavelength grating structure. In the exemplary embodiment, the micromirror pixels each congruently correspond to the sections 16 of the areas 32.

The micromirror pixels of the area 32 all have the same orientation and inclination, i.e. all the micromirror pixels of the surface area have matching orientation of the micromirrors within the micromirror pixels. This is not absolutely necessary, however. In accordance with a configuration that is not illustrated here, the orientation and/or the inclination of the micromirror pixels in the surface area can also vary.

FIGS. 7 to 9 show plan views of sections 16a to 16c of the security element 4, and FIG. 10 shows an elevation 28 in detail. FIGS. 7 to 10 serve to elucidate a preferred method for producing the security element 4, which is explained below.

FIG. 7 illustrates a first section 16a of a pixel 6 in the plan view. The section has a two-dimensional subwavelength structure in the form of depressions 30 and elevations 28, the latter being arranged in a square grid arrangement. This grid arrangement forms a first grating 40. The elevations 28 are present in the first grating 40 e.g. in such a way that a midpoint M of each elevation 28 becomes located on an intersection point of horizontal and vertical grating lines of the first grating 40. The midpoint M serves to elucidate a registration of the elevations 28 in the first grating 40. The midpoint M is depicted only for one elevation 28, for the sake of simplicity. The first grating 40 equally serves only to elucidate the arrangement of the elevations 28 in the section 16a; only by this means is it discernible in the plan view of the security element 4.

The grid arrangement in accordance with the first grating 40 is square by way of example, that is to say that the horizontal and vertical grating lines are at an angle of 90° to one another. However, grid arrangements in an e.g. hexagonal grating are also possible (not illustrated).

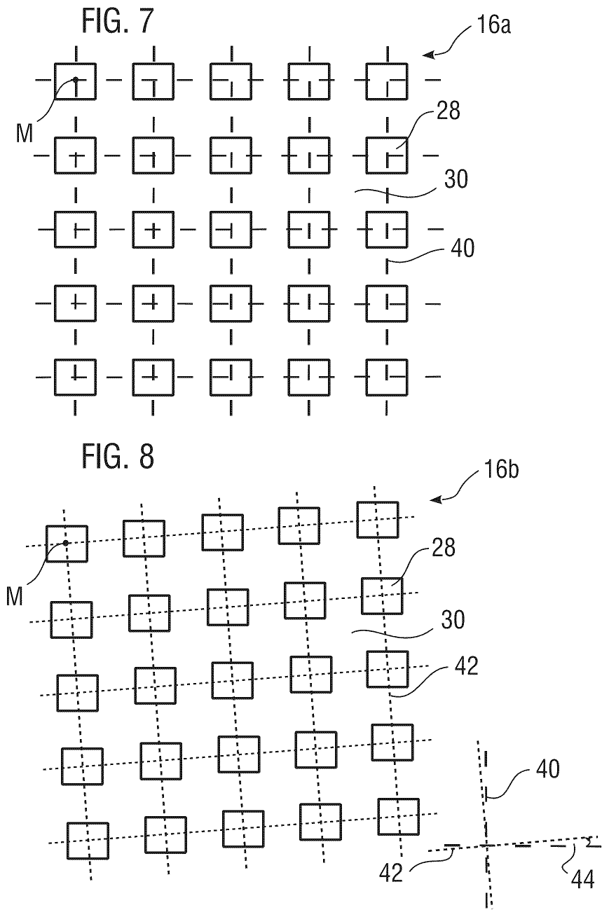

FIG. 8 shows a second section 16b of the pixel 6 in the plan view, in which section the azimuth angle is changed on the basis of a predetermined value in comparison with FIG. 7. This is achieved by the elevations being arranged in a second grating 42, which is rotated by a first angle 44 relative to the first grating 40, but otherwise has the same structure. In the exemplary embodiment in FIG. 8, the angle 44 is 10°. This rotation of the second grating 42 with respect to the first grating 40 by the angle 44 is illustrated as a detail for elucidation at the bottom right edge in FIG. 8. Independently of the rotation of the second grating 42 relative to the first grating 40 by the angle 44, the orientation of the elevations 28 remains the same in FIGS. 7 and 8, that is to say that in FIG. 8 the edges of the top side of the elevations 28 are parallel to those of the previous section 16a; they do not concomitantly rotate with the second grating 42.

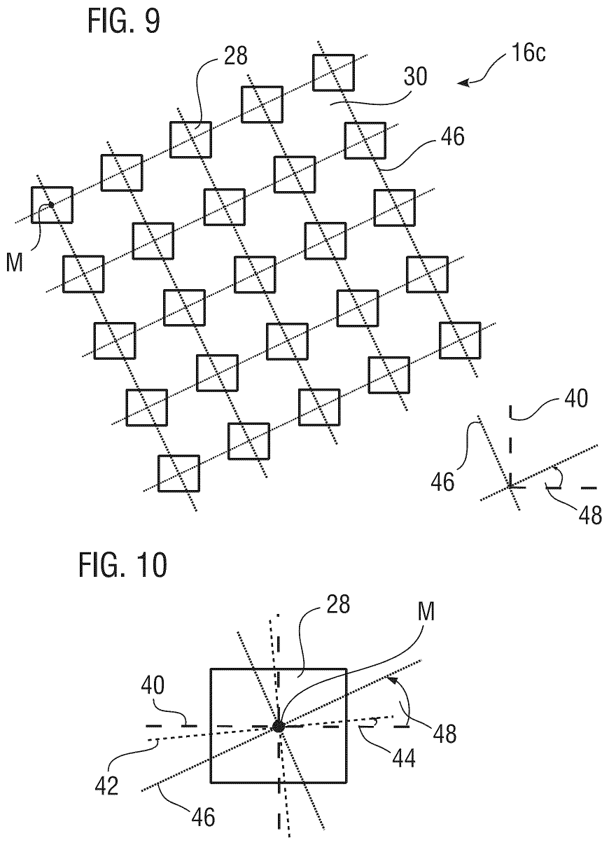

FIG. 9 shows a third section 16c of the pixel 6 in the plan view. As in FIGS. 7 and 8, elevations 28 are registered with their midpoints M on the intersection points of the grating lines of a third grating 46. The latter corresponds to the gratings 40 and 42 in terms of the basic structure, but is rotated by a second angle 48 of 30° relative to the grating 40. Independently of the rotation of the third grating 46, the orientation of the elevations 28 remains the same in FIG. 9 as well, that is to say that in FIG. 9 as well the edges of the top side of the elevations 28 are parallel to those of the sections 16a and 16b. The rotation of the third grating 46 with respect to the first grating 40 by the second angle 48 is illustrated as a detail at the bottom right edge in FIG. 9.

FIG. 10 shows an individual elevation 28 in the plan view. The elevation 28 has the midpoint M. The first grating 40, the second grating 42 and the third grating 46 are additionally illustrated, which are registered with the midpoint M of the elevation 28 in such a way that the midpoint M is situated on the intersection point of the grating lines of the gratings 40, 42, 46. In addition, the first angle 44 and the second angle 48 are illustrated, by which angles the second grating 42 is rotated vis-à-vis the first grating 40 and, respectively, the third grating 46 is rotated vis-à-vis the first grating 40.

FIGS. 7 to 9 show two-dimensional periodic grating structures with elevations 28 and depressions 30, arranged by way of example in a rectangular grid arrangement in the form of a square grating 40, 42, 46. It is possible to set the horizontal or vertical spacings between the elevations 28 to be equal to zero and thus to produce a one-dimensional periodic grating with grating ridges and gaps (this embodiment is not illustrated).

FIGS. 7 to 9 respectively illustrate a section 16a, 16b, 16c with a different azimuth angle. The edges of the elevations or the edges of the top sides of the elevations remain oriented identically, however, in each of FIGS. 7 to 9 (i.e. in all the sections), specifically parallel to the grating lines of the first grating 40 by way of example in the embodiments illustrated. FIG. 10 illustrates in summary that the orientation of the elevation 28 in the preferred production method always remains the same, independently of the grating 40, 42, 46.

In order to set the azimuth angle, the orientation of the elevations is maintained, but the second grating 42 is rotated relative to the first grating 40 and the third grating 46 is rotated relative to the first grating 40 by the azimuth angle.

In this production method, therefore, in order to produce different azimuth angles in different sections 16, the orientation of the regular periodic subwavelength gratings as a whole is varied, but the orientation of the elevations 28 remains the same.

### LIST OF REFERENCE SIGNS

2 banknote
4 security element
6 pixel
8 plan view direction
10 axis
12, 14 limit
16, 17 section
18 longitudinal direction
20 substrate
22 embossing lacquer layer
24 subwavelength grating structure
26 metallization
28 elevation
30 depression
32, 34, 35 area
36 micromirror arrangement
38 micromirror
40 first grating
42 second grating
44 first angle
46 third grating
48 second angle

1-22. (canceled)

23. A security element for valuable objects or valuable documents, which security element has on a substrate a subwavelength grating structure, which in perpendicular plan view exhibits a color generated on the basis of plasmon resonance,
wherein a multiplicity of sections which are not resolvable with the naked eye are formed, in each of which sections the subwavelength grating structure is uniformly formed,
wherein the subwavelength grating structures differ between the sections in terms of at least one structure parameter which influences light diffraction, and the multiplicity of sections which are not resolvable with the naked eye cover a surface area of the security element,
wherein the sections in the surface area differ in terms of the at least one structure parameter such that an observer does not perceive any rotation-angle-dependent diffraction effect in the surface area occupied by the sections when the security element is tilted about at least one tilt axis lying in a substrate plane.

24. The security element according to claim 23, wherein the subwavelength grating structures have a metallically coated relief profile,
wherein the metallic coating consists of aluminum, gold, silver, copper, chromium, nickel and/or iron or an alloy of these metals.

25. The security element according to claim 23, wherein the structure parameter in terms of which the subwavelength grating structures of the sections differ comprises at least one of the following parameters of the subwavelength grating structure: azimuthal orientation, period, contour of elevations and/or depressions of the subwavelength grating structure which are arranged regularly on a base area.

26. The security element according to claim 23, wherein the subwavelength grating structures of the sections differ in terms of the azimuthal orientation, wherein adjacent, different sections of the surface area have a variation of the azimuthal orientation of between 0° and 360°.

27. The security element according to claim 23, wherein the subwavelength grating structure is a two-dimensional periodic subwavelength grating structure, wherein the subwavelength grating structure has a rectangular, square, hexagonal or parallelogram-shaped grid arrangement.

28. The security element according to claim 27, wherein the subwavelength grating structure has regularly arranged elevations and/or depressions, wherein the subwavelength grating structures of the sections differ in the orientation of the grid arrangement.

29. The security element according to claim 23, wherein in the surface area the structure parameter is varied substantially isotropically.

30. The security element according to claim 23, wherein it has a plurality of surface areas.

31. The security element according to claim 23, wherein the surface area(s) is/are formed on a micromirror arrangement.

32. The security element according to claim 30, wherein the surface areas are each formed as a micromirror of a micromirror arrangement, as a micromirror pixel having a plurality of micromirrors of a micromirror arrangement with a uniform orientation, or as a multiplicity of micromirror pixels each having a plurality of micromirrors of a micromirror arrangement with a uniform orientation,
wherein the subwavelength grating structure of the sections of each micromirror or of each micromirror pixel or of each multiplicity of micromirror pixels imparts a specific color thereto, such that the micromirror arrangement generates a colorful or colored motif.

33. The security element according to claim 23, wherein the surface area(s) is/are resolvable with the naked eye.

34. The security element according to claim 23, wherein the multiplicity of sections which differ in terms of the at least one structure parameter are combined with one or more further sections, the structure parameters of which do not differ from one another.

35. A method for producing a security element for valuable objects or valuable documents,
wherein on a substrate a subwavelength grating structure is formed, which exhibits a color generated on the basis of plasmon resonance,
wherein a multiplicity of sections which are not resolvable with the naked eye are formed, in each of which sections the subwavelength grating structure is uniformly formed, wherein the subwavelength grating structures differ between the sections in terms of at least one structure parameter which influences light diffraction, and the multiplicity of sections which are not resolvable with the naked eye cover a surface area of the security element,
wherein in the surface area the sections differ in terms of the at least one structure parameter such that an observer does not perceive any rotation-angle-dependent diffraction effect in the surface area occupied by the sections when the security element is tilted about at least one tilt axis lying in a substrate plane.

36. The method according to claim 35, wherein the subwavelength grating structures are provided with a metallically coated relief profile.

37. The method according to claim 35, wherein the structure parameter in terms of which the subwavelength grating structures of the sections differ comprises at least one of the following parameters of the subwavelength grating structure: azimuthal orientation, period, contour of elevations and/or depressions of the subwavelength grating structure which are arranged regularly on a base area.

38. The method according to claim 35, wherein the subwavelength grating structures of the sections differ in terms of the azimuthal orientation, wherein adjacent, different sections of the surface area have a variation of the azimuthal orientation of between 0° and 360°.

39. The method according to claim 35, wherein in the surface area the structure parameter is varied substantially isotropically.

40. The method according to claim 35, wherein a plurality of surface areas are provided, which are each formed as a micromirror of a micromirror arrangement, as a micromirror pixel having a plurality of micromirrors of a micromirror arrangement with a uniform orientation, or as a multiplicity of micromirror pixels each having a plurality of micromirrors of a micromirror arrangement with a uniform orientation,
wherein the subwavelength grating structure of the sections of each micromirror or of each micromirror pixel or of each multiplicity of micromirror pixels imparts a specific color thereto, such that the micromirror arrangement generates a colorful or colored motif.

41. The method according to claim 35, wherein the surface area(s) is/are resolvable with the naked eye.

42. The method according to claim 35, wherein the subwavelength grating structure is formed as a two-dimensional periodic subwavelength grating structure,
wherein the subwavelength grating structure is applied to the substrate in a rectangular, square, hexagonal or parallelogram-shaped grid arrangement.

43. The method according to claim 42, wherein the subwavelength grating structure has regularly arranged elevations and/or depressions,
wherein the subwavelength grating structures of the sections differ in the orientation of the grid arrangement.

44. An article or a valuable object or a valuable document, having a security element according to claim 23.
